(19) United States
(12) Patent Application Publication
(10) Pub. No.: US 2007/0229047 A1
(43) Pub. Date: Oct. 4, 2007

(54) Tapped inductor buck dc-dc converter

(76) Inventors: James Sigamani, Quezon City (PH); Khanderao Madhav Gaikwad, Manila (PH)

Correspondence Address: HARNESS, DICKEY, & PIERCE, P.L.C, 7700 BONHOMME, STE 400, ST. LOUIS, MO, 63105, US

(21) Appl. No.: 11/396,423

(22) Filed: Mar. 31, 2006

(51) Int. Cl. G05F 1/00

(52) U.S. Cl. 323/282

(57) ABSTRACT

A buck dc-dc converter includes a tapped inductor having an active switch connected to the inductor tap and to a ground. A first diode is connected between the inductor and an input voltage source.

### FIELD

The present disclosure relates to dc-dc tapped inductor buck converters.

### BACKGROUND

The statements in this section merely provide background information related to the present disclosure and may not constitute prior art.

Two stage dc-dc converters have recently become common for use in relatively high input voltage and relatively low output voltage in high current applications. These two stages generally use buck converters as a first stage to regulate the output voltage. A second stage is generally an isolated dc-dc converter and operates at a fixed duty cycle. This second stage converter acts essentially as a dc-transformer to step down the voltage. The second stage converter can be any of a push-pull, half-bridge, forward, or a full-bridge converter.

These two stage converters have been recognized for their many benefits, including the use of low voltage rated MOSFETS, which provide a significant cost savings from previous converters. In addition, zero voltage switching for the primary side switches can be easily achieved, as well as improved thermal performance. These two stage converters are also attractive because large voltage conversion ratios can be achieved and are applicable to a wide voltage input range.

The duty ratio of the first stage buck converter is dictated by the hold-up time requirement. Because the dc-dc converter is an open-loop converter with a fixed duty rate, the step-down ratio of the isolation transformer depends on the duty ratio of the buck converter. For a given current rating of a MOSFET switch used, in for example a full-bridge converter, the efficiency of the open loop converter will be higher at a higher input voltage because the current through the devices will be less. Therefore, if the hold-up time is improved, the primary-to-secondary turns ratio can be increased and the efficiency of the converter can be increased.

It has been known to use tapped inductors in buck converters to alter the voltage stress on the devices of the converter. One such prior art tapped inductor buck converter is shown in FIG. 1 at numeral 10. Another prior art tapped inductor buck converter is shown in FIG. 2 at numeral 12. Typically, a MOSFET switch Q is connected between a voltage source Vᵢₙ and a tapped inductor, as shown. Diode D is connected between the tap of the inductor and ground. The two tapped inductor sections contain a number of windings represented by n1 and n2 in FIG. 1. Also, typically a bulk capacitor is connected between the inductor and ground and in parallel with a load. Depending on the tapped winding arrangement, the voltage of MOSFET Q can be increased or decreased. Tapping the inductor allows the gain of the buck converter to be changed for a given duty ratio. Particularly, a converter gain is changed to avoid extreme variations of duty ratio when the gain is required to be very small. For example, when a buck converter is used in telecom applications having an input voltage of 12V and output voltage of 1.5V, the duty ratio is 0.125. Using the tapped inductor arrangement shown in FIG. 1, the duty ratio can be increased to 0.222 with a tapped inductor ratio of only n=2. This can be seen from the following equations:
n=(n1+n2)/n1
D=(n×Vo)/(Vin+(n−1)×Vo)

### SUMMARY

A dc-dc buck converter includes a tapped inductor having an active switch connected to an inductor tap and to a ground. A first diode is also connected between the inductor and an input voltage source.

Another buck dc-dc converter disclosed, in addition to the above converter, includes a tapped inductor having two inductor sections with a second diode connected between the inductor sections. A capacitor is also connected across the second diode and one of the inductor sections. Also disclosed is a two stage dc-dc converter having a first stage tapped inductor buck converter of and a second stage dc-dc converter connected to the first stage converter for stepping down an output voltage of the first stage converter.

The advantages of using such a tapped inductor buck dc-dc converter as described in the present disclosure, includes increasing the hold-up time while reducing the voltage stresses on the free wheeling diodes, as compared to the prior art. The disclosed buck dc-dc converter also nearly eliminates turn-on losses and lowers turn-off losses, as compared to the prior art. In addition, cheaper ultra fast diodes can be used instead of costly tandem/SiC diodes of the prior art, reducing manufacturing costs of the disclosed buck dc-dc converter. Because the hold-up time has been increased, improvement in efficiency can be achieved.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a prior art schematic of a tapped inductor buck dc-dc converter;

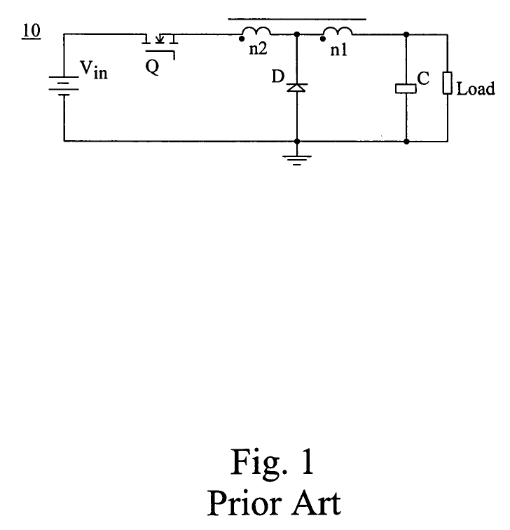

FIG. 2 is another prior art schematic of a tapped inductor buck converter;

FIG. 3 is a schematic circuit of an example of a tapped inductor buck dc-dc converter in accordance with the present disclosure;

FIG. 4 is a schematic diagram of yet another exampled of a tapped inductor buck dc-dc converter in accordance with the present disclosure; and

FIG. 5 is an example of a two stage dc-dc converter in accordance with the present disclosure.

### DETAILED DESCRIPTION

The following description is merely exemplary in nature and is not intended to limit the present disclosure, application, or uses.

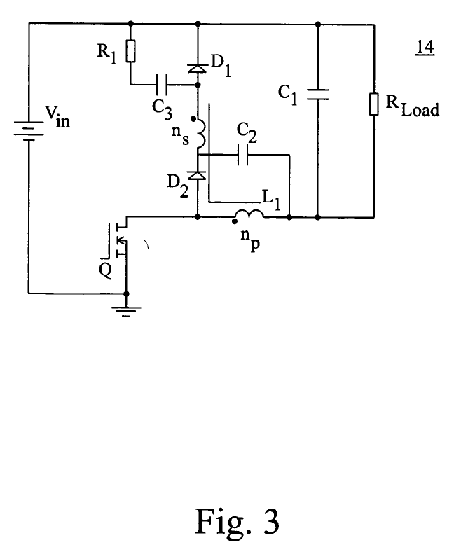

A buck dc-dc converter with a tapped inductor is shown at 14 in FIG. 3. Such a tapped inductor buck converter, as discussed above, can provide for improved hold-up time while reducing the voltage stresses on the semiconductor switches compared to the prior art, and can be used in high voltage applications, such as a 400V bus input. Buck dc-dc converter 14 includes a tapped inductor L1 that includes turns nₛ and nₚ, as shown. Tapped inductor L1 has an active switch Q connected to the inductor tap and to ground, as shown. Switch Q in the exemplary embodiments of the present disclosure is preferably a MOSFET device but could be other devices such as IGBTs or other suitable switches. A first diode D1 is connected between the inductor L1 and an input voltage source Vᵢₙ.

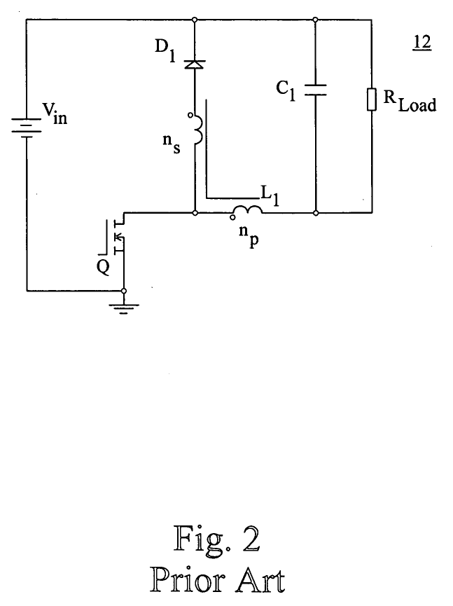

The converter 14 is modified from the converter 12 of FIG. 2, in that a second diode D2 is connected between the inductor sections nₛ and nₚ, and a capacitor C2 is connected across the second diode D2 and one of the inductor sections of inductor L1. The converter 12 will provide improved hold-up time compared to converter 10 but the free wheeling diode stress is higher for converter 12 as compared to converter 14. In addition, converter 12 relative to converter 14 has a very high voltage spike on the MOSFET due to the leakage inductor. Converter 14 nearly eliminates the MOSFET voltage spikes and reduces the free wheeling diode voltage stresses compared to the prior art.

The converter 14 may also include a series connected resistor R1 and a capacitor C3 connected in parallel with the first diode D1.

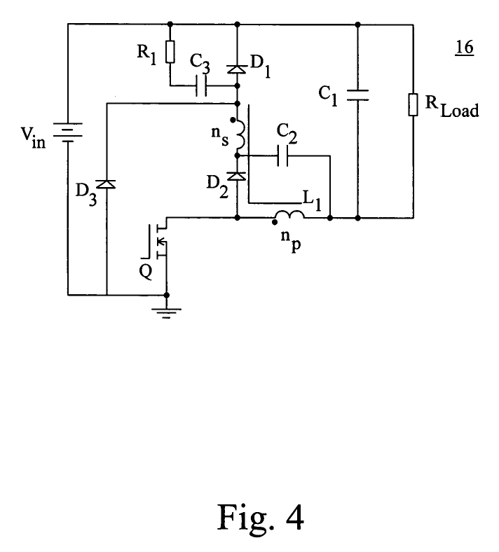

Another example of a buck dc-dc converter, in accordance with the present disclosure, is shown in FIG. 4 at 16 and includes all the elements of converter 14 described above. In addition, converter 16 includes a clamping diode D3 connected in parallel to inductor L1 and the switch Q for reducing a voltage spike due to a leakage inductance of the first diode D1.

During operation, prior to turning on the MOSFET Q, current is freewheeling through inductor L1, diode D1, bulk capacitor C1, the load, and capacitor C2. When the switch Q is turned on during tₒₙ, current is transferred to nₚ. Because the coupling between nₚ and nₛ will never be 100%, leakage inductance will occur. Because of this leakage inductance, the current transfer from nₛ to nₚ will be delayed. If the delay caused by the leakage inductance is greater than the MOSFET Q turn on time, the turn on switching losses may be eliminated. In addition, because of the existence of the leakage inductance, the di/dt of the current through the diode D1 is reduced as compared to a conventional buck converter. Because of this current reduction, the reverse recovery current of the freewheeling diode D1 is also reduced. The voltage stress on MOSFET Q is also reduced and therefore, turn off losses of Q are reduced.

When Q is turned off during t_{off}, the current in Q is transferred to diode D₂. After the leakage energy is recovered in capacitor C₂, the current is transferred to D₁, and will freewheel through nₛ as before.

The voltage stress of the buck dc-dc converters, in accordance with the present disclosure, are less than with a conventional buck converter. In experiments varying Vᵢₙ values and turns ratio values, and holding an output voltage at 310 volts, it was shown that the buck dc-dc converters, in accordance with the present disclosure, as compared to a conventional buck converter, reduced the voltage stresses on the circuit components. It was also shown that the optimum n value is two for the converters in accordance with the present disclosure, but in any case is greater than one.

By experimentation, it was shown that hold-up time improvement was 1.5 milliseconds compared to a conventional buck converter, and the efficiency improvement achieved by the conversion in accordance with the present disclosure was 0.5%.

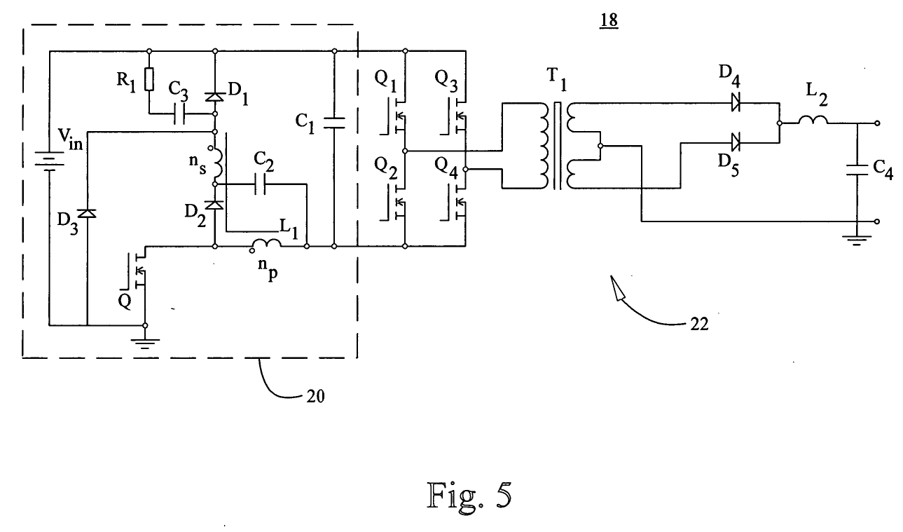

FIG. 5 shows a two stage dc-dc converter 18 in accordance with the present disclosure. A first stage tapped inductor buck converter is shown at dashed line 20. Converter 20 is essentially the same as converter 16 of FIG. 4 and includes an active switch Q connected to the inductor L1 tap and to a ground and a first diode D1 connected between the inductor and the input voltage source Vᵢₙ. The converter 20, though not shown, could also embody the converter 14 of FIG. 3. A second stage dc-dc converter shown generally at 22 is connected to the first stage 20 for stepping down an output voltage of the first stage converter 20.

The second stage dc-dc converter 22 can be any one of a push-pull, half-bridge, forward, or a full-bridge converter. The second stage converter 22, in this example, includes MOSFET switches Q1, Q2, Q3, and Q4 connected to a transformer T1. T1 in turn is connected to diodes D4 and D5. Diodes D4 and D5 are connected to inductor L2 and capacitor C4. Converter 22 is shown as an exemplary converter, but as stated above may be one of several different converter topologies depending on the requirements of a particular application.

The description of the present disclosure is merely exemplary and those skilled in the art will appreciate that variations other than those described will fall within the scope of the present invention.

What is claimed is:

1. A buck dc-dc converter comprising a tapped inductor having an active switch connected to the inductor tap and to a ground, and a first diode connected between the inductor and an input voltage source, wherein the tapped inductor has two inductor sections and wherein a second diode is connected between the inductor sections and a capacitor is connected across the second diode and one of the inductor sections.

2. The converter of claim 1 further including a series connected resistor and capacitor connected in parallel to the first diode.

3. The converter of claim 1 further including a capacitor connected in parallel with the first diode and inductor.

4. The converter of claim 1, wherein the switch is a MOSFET device.

5. The converter of claim 1, wherein the tapped inductor has two inductor sections and wherein a tapped inductor turns ratio of the two inductor sections is greater than one.

6. The connector of claim 4, wherein the inductor tap is connected to a drain of the MOSFET device and a source of the MOSFET device is connected to ground.

7. The converter of claim 1, wherein an anode of the first diode is connected to the inductor and a cathode of the first diode is connected to the input voltage source.

8. The converter of claim 1 further comprising a clamping diode connected in parallel to the inductor and the switch for reducing a voltage spike due to a leakage inductance of the first diode.

9. A two stage dc-dc converter comprising:
a first stage tapped inductor buck converter having an active switch connected to the inductor tap and to a ground and a first diode connected between the inductor and an input voltage source; and
a second stage dc-dc converter connected to the first stage converter for stepping down an output voltage of the first stage converter.

10. The converter of claim 9 further including a capacitor connected in parallel with the first diode and inductor.

11. The converter of claim 9 wherein the switch is a MOSFET device.

12. The converter of claim 9, wherein the tapped inductor has two inductor sections and wherein a tapped inductor turns ratio of the two inductor sections is greater than one.

13. The connector of claim 11, wherein the inductor tap is connected to a drain of the MOSFET device and a source of the MOSFET device is connected to ground.

14. The converter of claim 9, wherein an anode of the first diode is connected to the inductor and a cathode of the first diode is connected to the input voltage source.

15. The converter of claim 9, wherein the tapped inductor has two inductor sections and wherein a second diode is connected between the inductor sections and a capacitor is connected across the second diode and one of the inductor sections.

16. The converter of claim 9 further comprising a clamping diode connected in parallel to the inductor and the switch for reducing a voltage spike due to a leakage inductance of the first diode.

17. The converter of claim 15 further including a series connected resistor and capacitor connected in parallel to the first diode.

18. The converter of claim 9, wherein the second stage converter is one of a push-pull, half-bridge, forward, or a full-bridge converter.

19. A two stage dc-dc converter comprising:
a first stage tapped inductor buck converter having an active switch connected to the inductor tap and to a ground and a first diode connected between the inductor and an input voltage source;
wherein the tapped inductor has two inductor sections and wherein a second diode is connected between the inductor sections and a capacitor is connected across the second diode and one of the inductor sections; and
a second stage dc-dc converter connected to the first stage converter for stepping down an output voltage of the first stage converter.

20. The converter of claim 19 further including a capacitor connected in parallel with the first diode and inductor.

21. The converter of claim 19 wherein the switch is a MOSFET device.

22. The converter of claim 19, wherein the tapped inductor has two inductor sections and wherein a tapped inductor turns ratio of the two inductor sections is greater than one.

23. The connector of claim 21, wherein the inductor tap is connected to a drain of the MOSFET device and a source of the MOSFET device is connected to ground.

24. The converter of claim 19, wherein an anode of the first diode is connected to the inductor and a cathode of the first diode is connected to the input voltage source.

25. The converter of claim 19 further comprising a clamping diode connected in parallel to the inductor and the switch for reducing a voltage spike due to a leakage inductance of the first diode.

26. The converter of claim 19 further including a series connected resistor and capacitor connected in parallel to the first diode.

27. The converter of claim 19, wherein the second stage converter is one of a push-pull, half-bridge, forward, or a full-bridge converter.
